(19) United States
(12) Patent Application Publication
(10) Pub. No.: US 2005/0015276 A1
(43) Pub. Date: Jan. 20, 2005

(54) Computerized risk management module for medical diagnosis

(76) Inventors: Dan Sullivan, Oakbrook, IL (US); Mark Crockett, Naperville, IL (US); John Epler, Evanston, IL (US); Robert Hilgart, Chicago, IL (US)

Correspondence Address: MCANDREWS HELD & MALLOY, LTD, 500 WEST MADISON STREET, SUITE 3400, CHICAGO, IL, 60661, US

(21) Appl. No.: 09/928,130

(22) Filed: Aug. 10, 2001

Related U.S. Application Data
(63) Continuation of application No. 09/705,058, filed on Nov. 2, 2000, now abandoned.
(60) Provisional application No. 60/244,496, filed on Oct. 31, 2000.
(60) Provisional application No. 60/245,255, filed on Nov. 2, 2000.

(51) Int. Cl. G06F 17/60

(52) U.S. Cl. 705/2

(57) ABSTRACT

Apparatus is provided including an input device, a medical risk database, a data processor, and a communication device. Data entered in the input device, usually by a health care professional, defines a patient data record. The medical risk database associates certain patient data entered into the data record, which increases the risk of a missed medical care opportunity, with additional medical care to address the risk. The communication device responds to the identification of patient data presenting a medical risk by communicating to a health care professional additional medical care selected to identify and take advantage of a medical care opportunity. Templates are also disclosed having “red light green light” indicators that indicate red to prompt consideration of a system and green to indicate it has been considered. A triage template and key information to provide additional information to the diagnosing or treating professional are also provided.

### CROSS-REFERENCE TO RELATED APPLICATIONS

This application claims priority of provisional applications filed on Oct. 31, 2000, Ser. No. 60/244,496, attorney docket no. 12917US01, and Ser. No. 60/245,255, filed Nov. 2, 2000, and is a continuation of application Ser. No. 09/705,058, filed Nov. 2, 2000, and also entitled: “Computerized Risk Management Module for Medical Diagnosis,” naming the same inventors. The entire text and drawings of the applications identified above are incorporated here by reference.

### STATEMENT REGARDING FEDERALLY SPONSORED RESEARCH OR DEVELOPMENT

Not Applicable.

### BACKGROUND OF THE INVENTION

This invention generally relates to apparatus and methods for improving medical care. (“Medical care” is broadly defined here to include both medical diagnosis and therapeutic treatment of a patient.) This invention relates more particularly to such apparatus and methods that can be used by a health care professional to avoid making the kinds of professional mistakes that can lead to a significant risk of legal liability.

“Health care professionals” is used broadly here to refer to anyone who participates in the diagnosis or treatment of medical problems. For example, medical doctors, dentists, nurses, nurse-practitioners, medical technologists, physical therapists, and other health workers that assist in examination of patients, diagnosis, or treatment are all included by this term.

A health care professional diagnoses an illness by collecting and evaluating information about the patient, then determining what disease or condition best fits the information. The information gathered from the patient usually is processed to reach a diagnosis by using a protocol learned during the professional's professional training and modified and updated by his or her medical experience. The protocol is an ordered process by which a health care professional ascertains information that allows the professional to rule out possible diseases until enough information is gathered to eliminate all but the diagnosed condition. Alternatively, the protocol may end when an appropriate treatment is identified. Recently, medical associations, health maintenance organizations, and hospitals, among others, have prescribed protocols. Employed health care professionals in particular are often subject to mandated protocols.

One problem in the field of medicine is how to improve diagnostic protocols to take into account advances in medical knowledge. A related problem is how to ensure that health care professionals update their skills to take advantage of advances in medical knowledge. Still another problem is how to expedite the diagnosis and treatment of certain conditions that should be treated quickly, so treatment can begin soon enough to be most effective.

U.S. Pat. No. 6,095,973 discloses a data processing system and method for evaluating the treatment of chest pain patients in a medical facility. The system accepts actual patient treatment information from a clinical setting and predetermined appropriate patient treatment information from a source of that information. The system compares the actual patient treatment information to the treatment that is considered appropriate, and reports the results of its comparison so that the medical facility is able to improve its treatment of chest pain patients.

U.S. Pat. No. 6,029,138 discloses a decision support system for the selection of a diagnostic test or therapeutic intervention, which are both called “studies” in that patent. The system identifies how often significant results were obtained in prior studies having the same indications. The number of studies performed for which results were significant for the same indications, as a proportion of the total number of studies performed for the same indications, is provided as feedback to the ordering physician. This patent states that decision support can be enhanced by using data extracted from existing scientific literature respecting how appropriate a study is, given the indications reported by the ordering physician.

U.S. Pat. No. 4,857,713 discloses a program for reducing hospital errors in the delivery of medications, goods, services or procedures in patient treatment. The patient wears a wrist identification band with a preprinted computer-readable code. Unit doses of medications or goods available for administration are provided with preprinted computer-readable codes. A portable computer is loaded with a physician's orders for medications, goods, services or procedures for specific patients. Before medications, goods, services or procedures are administered to a patient, hospital personnel will scan the machine-readable codes on the patient's identification band, and then on the unit dose(s) of the medications, goods, services, or procedures. The portable computer will compare these readings with the doctor's orders and other internal files as required and verify that the administration of the identified medications, goods, services or procedures is either correct or not correct.

In the system described in U.S. Pat. No. 5,517,405, a user enters a medical condition and a proposed medical procedure to treat the condition. In one mode, the system dynamically generates questions in response to previous information provided by the user to determine and then communicate whether the proposed treatment is appropriate.

U.S. Pat. No. 5,732,397 describes an automated system for use in decision-making processes which is said to improve the quality and consistency of decisions made. Medical decisionmaking is discussed, for example, from col. 3, line 49 to col. 4, line 6, and from column 5, line 47 to col. 8, line 47.

U.S. Pat. No. 5,772,585 discloses a common user interface to allow different medical personnel access to centralized files regarding patients. The system allows health care professionals to concurrently record examination and diagnosis notes in a database during patient examination. The system is said to provide a common graphic user interface capable of accessing all necessary tasks through a common database structure. The system displays allergy warnings and records a diagnosis based on the progress notes.

U.S. Pat. No. 5,832,450 describes an electronic medical record system that stores data about individual patient encounters in a convenient form.

U.S. Pat. No. 5,845,255 describes an electronic prescription creation system for physician use that includes an adverse indication review and online access to comprehensive drug information including scientific literature. This patent also provides an extensive background on the problems of automating patient data record systems for physicians.

U.S. Pat. No. 5,911,132 discloses diagnosing and treating patient diseases using a epidemiological database containing medical, personal or epidemiological data relevant to a presented set of symptoms, test results, a diagnosis, etc. For example, if a food poisoning epidemic breaks out in a particular place, the epidemiological database computer facility will begin to receive from that place epidemiological transaction records in which “food poisoning” is listed as being at least the tentative diagnosis. When this happens, the computer facility returns an electronic data communication to a physician submitting such a patient transaction record a suggestion that food poisoning be considered as a likely source of the patient's problems.

U.S. Pat. No. 5,915,240 discloses a context-sensitive medical lookup reference computer system for accessing medical information over a network.

U.S. Pat. No. 5,924,074 discloses a medical records system that is said to create and maintain all patient data electronically. The system captures patient data, such as patient complaints, lab orders, medications, diagnoses, and procedures, at its source at the time of entry. Authorized healthcare providers can access, analyze, update and electronically annotate patient data even while other providers are using the same patient data record. The system is said to permit instant, sophisticated analysis of patient data to identify relationships among the data considered. Moreover, the system is said to include the capability to access reference databases for consultation regarding allergies, medication interactions and practice guidelines.

U.S. Pat. No. 5,953,704 discloses a system in which a user inputs information related to the health condition of an individual. Guideline treatment options are identified by the system. The user is also said to be able to input actual or proposed and final recommendation treatments for the individual. The patent states that the resulting comparative information can be used to modify the actual or proposed treatment.

U.S. Pat. No. 6,022,315 discloses a system and method for providing computerized, knowledge-based medical diagnostic and treatment advice to the general public over a telephone network or a computer network.

The patents discussed above are not understood to disclose a system that communicates to a health care professional carrying out a diagnosis that a certain symptom, combination of symptoms, or other patient information recorded by the physician is associated with an increased risk of a missed medical care opportunity leading to a less favorable patient outcome. (A “medical care opportunity” is defined as an opportunity to correctly or more quickly diagnose or treat the patient's condition and thus provide a better patient outcome.) Nor does the disclosed apparatus communicate to the health care professional special steps to take to avoid the missed medical care opportunity.

### BRIEF SUMMARY OF THE INVENTION

One aspect of the invention is apparatus for improving the medical care of patients. The apparatus includes an input device, a medical risk database, a data processor, and a communication device.

The input device can be any device that is useful for entering medical data presented by a patient. Data entered in the input device defines a patient data record.

The medical risk database associates certain patient data, which increases the risk of a missed medical care opportunity, with additional medical care. The additional medical care is predetermined action that reduces the risk of a missed medical care opportunity, despite the presentation of the patient data.

The data processor is programmed to compare the patient data record with the medical risk database. This comparison is carried out to identify patient data in the record that increases the risk of a missed medical care opportunity.

The communication device responds to the identification of patient data that increases the risk of a missed medical care opportunity. The communication device responds by communicating to a health care professional additional medical care. The additional medical care is selected to reduce the risk of a missed medical care opportunity.

Another aspect of the invention is an interactive method a health care professional can use for avoiding medical risk while the health care professional is providing medical care to a patient.

The health care professional records medical data presented by the patient in a data storage device, forming data records.

The health care professional has access to a medical risk database maintained on a data storage medium. The database associates certain medical data with additional medical care. The certain medical data is data that increases the risk of a missed medical care opportunity. The additional medical care is something that can be done to reduce the risk of a missed medical care opportunity, despite the presentation of the certain medical data.

A data processor is used to compare the medical data presented by the patient with the medical data in the medical risk database to identify whether medical data presented by the patient is associated with a risk of missed medical care opportunity.

If medical information presented by the patient is associated with a risk of missed medical care opportunity, information about additional medical care that would reduce the risk of a missed medical care opportunity is presented to the health care professional.

Another aspect of the invention is an interactive diagnostic template for medical diagnosis. The template includes indicia (which can be text, a symbol or icon, spoken information, or other identifying information) indicating potential symptoms contributing to a diagnosis. Indicia are provided for at least two different kinds of symptoms.

A first group of symptoms are prompted symptoms that are recommended to be checked to properly document the diagnosis. A second group of symptoms are optional symptoms that can be checked at the option of an attending health care professional.

Symbols are associated with the prompted symptoms. The symbols have a first condition when the evaluation of a prompted symptom has not yet been documented and a second, visibly distinct condition when evaluation of the prompted symptom has been documented. For example, but without limitation, the first condition of the symbols can be a representation of a lit red light, and the second condition of the symbols can be a representation of a lit green light. The medical professional can be advised that she or he can pass by a symptom if a green light is lit, but that it is recommended that he or she stop and evaluate a symptom if a red light is lit.

Optionally, additional indicia can be provided indicating at least one conditionally prompted symptom. A conditionally prompted symptom is prompted when at least a first other associated prompted symptom is present but not prompted if the other associated prompted symptom is absent. A symbol associated with the conditionally prompted symptom is activated only if the associated prompted symptom is documented. When the associated prompted symptom has been documented, the symbol for the conditionally prompted system is activated. It can have two conditions, again indicating whether the conditionally prompted symptom has been documented or not.

Still another aspect of the invention is an interactive diagnostic template for medical triage of a patient. The triage template is a display presenting a list of acute emergencies that require immediate notification to a treating medical professional to avoid death or grave injury of the patient. The template presents a symbol associated with the acute emergency list that has a first condition prompting a triaging medical professional to evaluate whether any of the acute emergencies exists and a second, visibly distinct condition when the triaging medical professional has ruled out all of the acute emergencies. Alternatively, the symbol may be displayed next to smaller groups of conditions or individual conditions. The triage template or associated components presents a warning signal to the triaging medical professional, responsive to the documentation of an acute emergency, to notify a treating medical professional immediately.

Even another aspect of the invention is an interactive diagnostic template for medical diagnosis. This template again includes indicia indicating potential symptoms contributing to a diagnosis. A key information icon is associated with at least one potential symptom, indicating that additional information pertinent to the potential symptom is available for review upon request. An input device is provided to allow the medical professional using the template to request a display of the additional information associated with the icon.

Some examples of additional information that can be provided include:
an anatomical drawing of the site of the symptom associated with the icon;
a diagnostic score relating to the symptom associated with the icon;
an update on the standard of care relating to the symptom associated with said icon; or
information on how to test for the symptom associated with the icon.

### BRIEF DESCRIPTION OF THE SEVERAL VIEWS OF THE DRAWING

FIG. 1 is a schematic view of one example of a medical charting system suitable for carrying out the present invention.

FIG. 2 shows a portion of an exemplary medical diagnostic template for use with the system of FIG. 1 when diagnosing chest pain.

FIG. 3 is similar to FIG. 2, but shows the template modified to display an activated medical risk icon when an entry is made on the template that the patient has chest pain radiating to the back.

FIG. 4 is a pop-up legend presented by the system when the activated medical risk icon is queried to determine the nature of the medical risk.

FIG. 5 is a schematic view of a portion of the chest pain electronic medical record template with nine sets of red light, green light prompts. The prompts are all red, in their condition when the template is first displayed but has not yet been modified by entering information about symptoms.

FIG. 6 is a schematic view of a later portion of the same template shown in FIG. 5. No red light, green light prompt is initially displayed next to “Bilat. BP's” (bilateral blood pressures) on the template as initially displayed.

FIG. 7 is a schematic view of the chest pain electronic medical record template with the nine sets of red light, green light prompts all turned green. The “location” section has been marked to indicate that the pain is “substernal” and “radiating to back.”

FIG. 8 is a schematic view of a later portion of the same template shown in FIG. 7. Now a red light, green light prompt is initially displayed next to “Bilat. BP's” (bilateral blood pressures) on the template, responsive to the documentation of pain radiating to the back earlier on the same chart.

FIG. 9 is a bar chart showing the results of a medical research study published in the Supplement to Annals of Emergency Medicine ACEP Research Forum, Oct. 23-23, 2000, which is incorporated here by reference. FIG. 9 demonstrates compliance with five historical elements of the chest pain evaluation using dictated medical records and the electronic medical record with red light green light prompting.

FIG. 10 is a schematic view of a portion of the electronic medical record shoulder injury template prior to clicking on the key information icon for shoulder anatomy.

FIG. 11 demonstrates the electronic medical record shoulder injury template after clicking on the key information icon for shoulder anatomy, displaying a drawing of shoulder anatomy.

### DETAILED DESCRIPTION OF THE INVENTION

While the invention will be described in connection with one or more embodiments, it will be understood that the invention is not limited to those embodiments. On the contrary, the invention includes all alternatives, modifications, and equivalents as may be included within the spirit and scope of the appended claims.

The present inventors have discovered a previously overlooked source of information from which appropriate diagnostic protocols can be developed: the results of medical malpractice claims. Each malpractice claim represents a decision made by a patient that his or her medical care was not appropriate and harmed him or her.

For example, a course prepared by inventor Daniel J. Sullivan, M.D., J. D., High-Risk Acute Care: The Failure to Diagnose (1998) identifies missed medical diagnoses as the principal cause of most malpractice suits. A missed medical diagnosis is defined here to include either the wrong diagnosis or a delayed diagnosis that leads to a materially worse patient outcome. This conclusion was reached by studying over 1000 medical malpractice suits to determine what caused the alleged malpractice and what could be done to avoid the alleged malpractice. High-Risk Acute Care: The Failure to Diagnose (1998) is incorporated here by reference.

Data about medical malpractice claims has limited scientific value because the data is strongly influenced by non-medical factors. These factors include the differences among the jurors and judges involved in different cases, how credible, worthy, or attractive the plaintiff, the physician, and other parties and witnesses may appear to be, and the skill of the respective lawyers. Other factors include differences in the laws of different states and the common unavailability of data for many claims, particularly claims that are resolved by private settlement instead of by public judgment.

The outcome of cases that proceed to trial depends on whether jurors agree that the care given to the plaintiff that led to the filing of the lawsuit was appropriate.

The amount of damage awarded to a successful plaintiff reflects the jury's impression of how much worse the patient outcome was economically, compared to what it should have been. By putting a dollar value on the harm suffered by the plaintiff, a jury verdict reflects how much importance should be attached to the alleged error in patient care. Again, the medical or scientific communities do not commonly gather this information. It can only be obtained from litigation results.

Despite its limited scientific value, information obtained by studying medical malpractice claims is vitally important to improve diagnostic protocols. Medical malpractice claim experience largely reflects the attitudes of nonscientific, untrained, ordinary people. Such people have no connection with the scientific or medical worlds. The information they provide is not reflected in the usual diagnostic protocols, but often should be.

The present invention is not limited to information derived from medical malpractice claims. Any source of the required information, such as clinical experience, scientific experimentation, or the opinions of expert health care professionals is contemplated to be useful here.

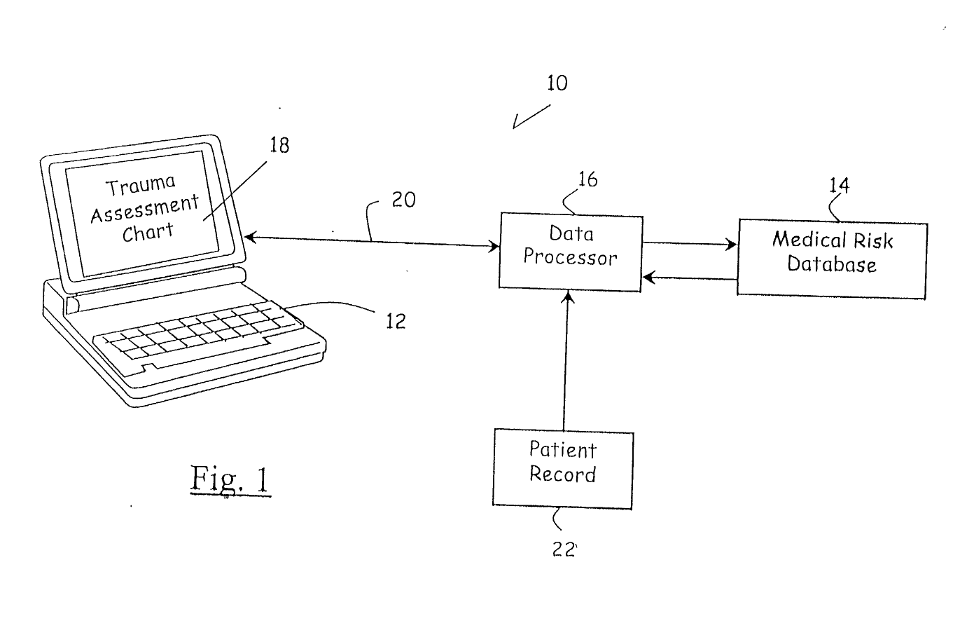

One embodiment of the invention is the medical charting system 10 shown in FIG. 1. The system 10 generally includes an input device 12, a medical risk database 14, a data processor 16, a communication device 18, and a data link 20.

The input device 12 can be any device that is useful for entering medical data presented by a patient. Data entered in the input device defines a patient data record.

One suitable input device is a cursor-moving device. A cursor moving device can be a pointing device such as a mouse, a track ball, a touchpad, a joystick, a voice-activated cursor directing program, a touch screen that moves a cursor responsive to finger or stylus placement or movement on the screen, etc.

Another suitable input device is a text entry device. A text entry device can be a keyboard for directly entering alphanumeric characters or other information directly. A non-alphanumeric keyboard can also be used, for example, a keyboard that has programmed keys directly representing the answers to medical questions indicative of medical information. A text entry device can be a text-generating device that converts spoken or handwritten words or characters into text entries. Two examples of text generating devices are a dictation program and the stylus and tablet of a personal digital assistant. Another suitable text entry device is a scanner for reading or copying alphanumeric text, a bar code, or other indicia.

Another type of input device contemplated here is a mechanism for transmitting data to the system 10 from a medical instrument. Examples of suitable medical instruments are an electrocardiograph, an electroencephalogram (EEG), a blood pressure measuring instrument, a pulse monitor, a thermometer, a laboratory machine, an intravenous drug administration monitor, or any others.

Yet another type of input device contemplated here is a communication device allowing a patient to enter data on his or her own patient record. It is advisable to identify the information so entered as coming from the patient, and to limit access of the patient so only appropriate portions of the patient record, such as the portion input by the patient, can be accessed by the patient, and so pertinent information cannot be erased or changed by the patient after it is entered.

Even another type of input device contemplated here is a magnetic strip reader for extracting information from a card carried by the patient, such as medical information that could be recorded on a patient-carried emergency medical information card or insurance card.

Still another type of input device contemplated here is a communication link between preexisting patient records and the medical charting system 10, as for communicating medical history or previous medical treatment information.

The input device is used to input information about a patient. The information is stored as a patient data record 22. Examples are given below of patient record data that is pertinent to determining medical risks.

The patient data record 22 is physically embodied as data stored in any suitable medium. Suitable media include a hard drive, a floppy drive, a tape drive, a magnetic strip (as is often found on a credit card), or any other magnetic medium. Other suitable media include a CD, the internal memory of a computer, information written on paper or in microfiche form (either readable by a computer or by a physician), or in any other form, without limitation. The data in the patient data record 22 can be digital or analog data in text, numerical, graphic, audible, or any other form perceivable by a health care professional.

The patient data record 22 can be physically stored anywhere. For example, the patient data record 22 can be located in a drive of a portable computer, such as a notebook computer or a personal digital assistant, also providing the input device 12, data processor 16, and communication device 18 for the system. This could be a self-contained system carried by a health care professional and used for medical charting. Alternatively, the patient data record 22 can reside in a remote drive, computer, or server, as shown in FIG. 1, and be accessed via a data link 20.

The medical risk database 14 associates certain patient data, which increases the risk of a missed medical care opportunity, with additional medical care. The additional medical care is predetermined action that reduces the risk. Examples of the information in the medical risk database 14 are provided below.

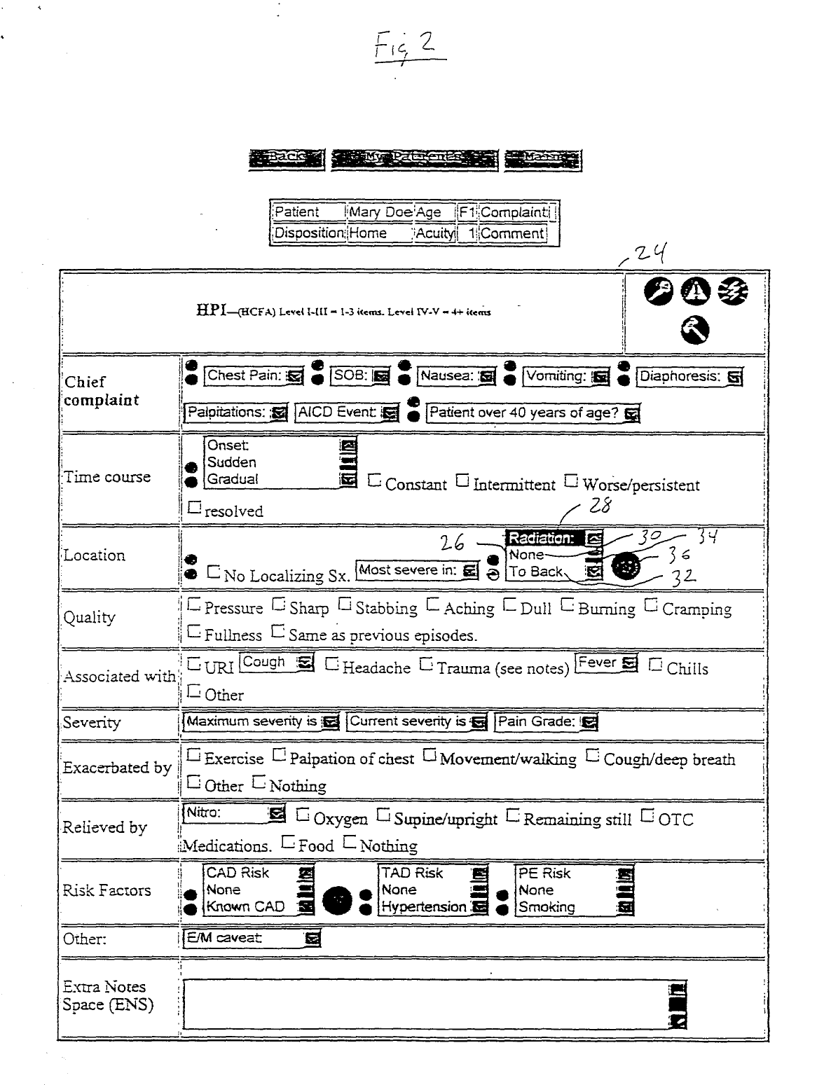

The medical risk database 14 is physically embodied as data stored in any suitable medium. Suitable magnetic media include a hard drive, a floppy drive, a tape drive, a magnetic strip such as the type often found on a credit card, or any other magnetic medium. Other suitable media include a CD, the internal memory of a computer, information recorded in paper or microfiche form (either readable by a computer or by a physician), or in any other form. The data in the medical risk database 14 can be digital or analog data in text, numerical, graphic, audible, or other perceivable form. The media in which the medical risk database and patient data record can be stored can be the same medium or different media. Either of them can be stored in more than one place or in more than one medium. In a simple embodiment, the database 14 can be built into the template 24 shown in FIG. 2 below, so entering certain patient data can prompt the presentation of a message that certain medical action is recommended.

The medical risk database 14 can be physically located anywhere. For example, the medical risk database 14 can be located in a drive of a notebook computer or personal digital assistant also providing the input device 12, data processor 16, and communication device 18 for the system. Alternatively, the medical risk database 14 can reside in a remote drive or computer, as shown in FIG. 1, and be accessed via a data link 20.

The medical risk database 14 can be updated to reflect recent medical or legal experience. The updated database can be updated by providing a subscription CD or Internet download service, by updating a central database that is accessed by many health care professionals, or by any other effective method.

The data processor 16 is programmed to compare the patient data record 22 with the medical risk database 14. This comparison is carried out to identify patient data in the record 22 that increases the risk of a missed medical care opportunity. The data processor 16 can have any suitable form or configuration. It can be a dedicated microprocessor, a programmed general-purpose computer, or any other mechanical or electronic processing device. In a simple form of the system, the data processor can be used simply to update the display to present a communication, responsive to the entry of certain patient data.

The communication device 18 is any type of device that communicates to a health care professional the presence of an increased medical risk, based on the identification by the data processor of information in the patient data record 22 that increases the risk of a missed medical care opportunity. The communication device 18 responds by communicating to a health care professional proposed additional medical care. The additional medical care is selected to reduce the risk of a missed medical care opportunity.

One suitable embodiment of the communication device 18, illustrated in FIG. 1, is a video display operatively connected to the data processor 16 to display an indication of appropriate additional medical care. Another suitable embodiment of the communication device 18 is an alarm providing a signal perceptible to a health care professional. The alarm can be a visible warning, like a symbol on a graphical display or a warning light. The alarm can be an audible warning. The alarm can be a tactile warning, such as a signal sent to a vibrating pager, cellular telephone, or personal digital assistant worn or carried by the health care professional. The alarm can also be presented remotely, as to another health care professional who can attend to the alarm condition. In various embodiments, the alarm can be presented locally only, remotely only, or both locally and remotely.

The alarm can be arranged to ordinarily be selectively perceptible to a health care professional and not to the patient. For example, it can be presented as a visual display on a terminal screen that is selectively viewable from one angle, presented toward the health care professional, and not from another angle where the patient's eyes are positioned.

The alarm can be encoded, to avoid alarming a patient who happens to encounter it. For example, it can be presented as a non-threatening icon on a visual display or a non-threatening sound. For another example, it can be made to appear or sound like something ordinary in the medical environment, such as an innocuous page on a public address system that is known only to the health care professional to relate to patient data being entered.

The data link 20 can be any means of communication of voice, data, or visual information now known or developed in the future. For example, the link 20 can be a telephone line, an Internet communication pathway (such as a telephone modem link, a dedicated link, a cable modem link, or a satellite link), computer wiring in a hospital or medical office, or any other communication path.

Another aspect of the invention is an interactive method a health care professional can use for avoiding medical risk while the health care professional is providing medical care to a patient.

The health care professional records medical data presented by the patient in a data storage device, forming a patient data record 22.

The health care professional has access to a medical risk database 14 maintained on a data storage medium. The database 14 associates certain medical data in the patient data record 22 with additional medical care. The health care professional uses a data processor 16 to compare the medical data presented by the patient data record 22 with the medical data in the medical risk database 14 to identify whether medical data presented by the patient is associated with a risk of missed medical care opportunity. If so, information about additional medical care that would reduce the risk of a missed medical care opportunity is presented to the attending medical health care professional.

### EXAMPLES OF ASSOCIATIONS IN THE MEDICAL RISK DATABASE

Examples 1-5 presented in tables at the end of this specification are examples of associations between patient data, increased medical risk, and one or more proposed medical responses that can optionally be made by the medical risk database 14. Two examples of proposed medical responses are diagnostic steps, as shown in several of the examples, or treatment steps, shown for example in the Neck Pain table of Example 2.

The associations presented here are merely exemplary. A skilled health care professional who is familiar with the present disclosure and investigates medical liability results can readily find additional or alternative associations of the same type, useful for addressing the same or other medical conditions. Medical risk information is available from Daniel J. Sullivan, M.D., J. D., High-Risk Acute Care: The Failure to Diagnose (1998). This publication is incorporated by reference. A medical risk database incorporated in the PulseCheck® medical charting system is commercially available from IBEX Systems Group, Ltd. sometimes known as IBEX Healthdata Systems, 5600 N. River Road, Suite 150, Rosemont, Ill. 60018. The templates and medical risk data of the PulseCheck® medical charting system are incorporated by reference here.

No representation is made that a health care professional should always follow the proposed advice, since it is not wise to rely solely on a preprogrammed database, unassisted by the judgment of a health care professional. The purpose of the medical risk database is simply to provide timely information to the health care professional that identifies and addresses a risk as it is presented.

Communication of Medical Risk

FIG. 2 shows a portion of an exemplary diagnostic template 24 that can be displayed on the communication device 18 when diagnosing a patient who complains of chest pain. The template 24 is shown in its initial condition, before a health care professional begins to respond to questions raised by the template. For example, the template 24 includes a query 26 to determine whether the chest pain is radiating toward the back. If not, “none” is marked by placing the cursor 28 on the “none” legend 30 for that answer and activating the choice (as by clicking a mouse button, if the cursor is moved by a mouse). The communication device 18 then displays that answer and the user is free to move on to other questions.

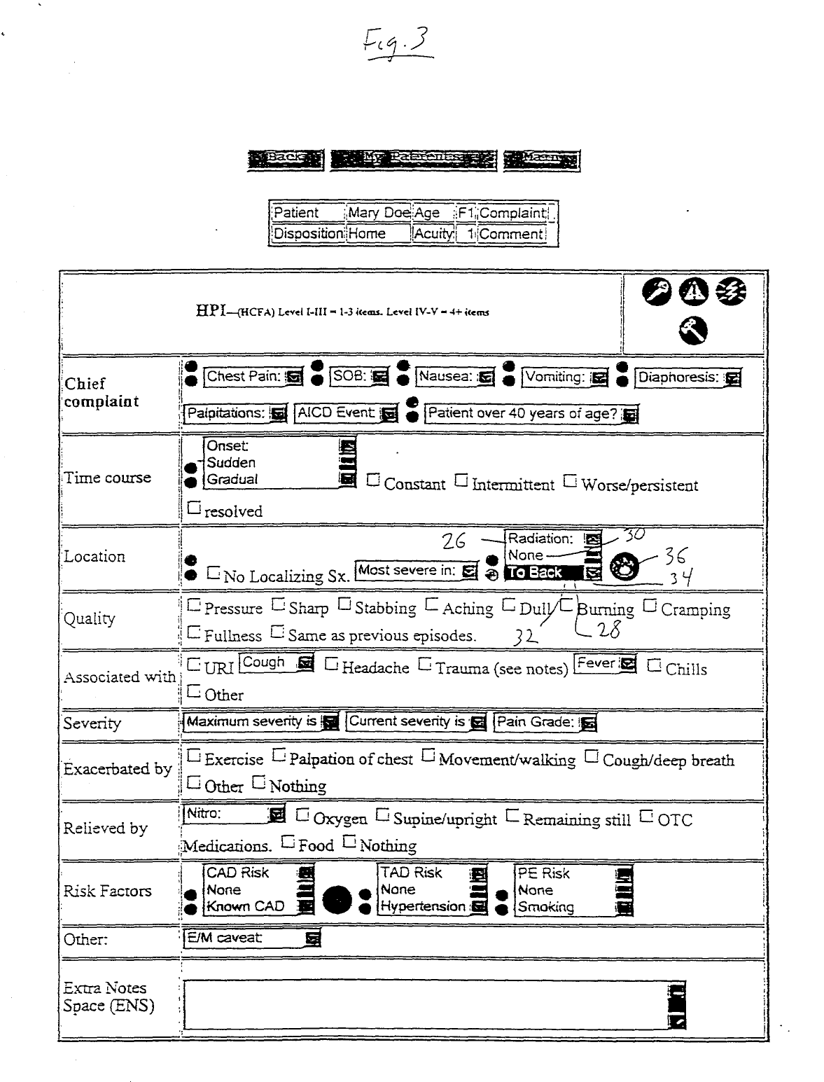

If the health care professional determines that the patient has chest pain radiating toward the back, “yes” is marked by placing the cursor 28 on the “to back” legend 32 for that answer and activating the choice. Other choices not shown in FIG. 2 are accessed by operating a scrolling button 34. Responsive to that answer, an icon 36 indicative of an increased medical risk is presented on the communication device 18. This icon 36 is displayed in FIG. 3, and is a fire-shaped, brightly colored icon that contrasts by its larger size and brighter red and orange colors with other indicia on the template 24. The icon 36 is also visible in FIG. 2, but is muted in color in FIG. 2 because it is not activated. The icon 36 is present in muted form before it is activated so a health care professional will not overlook the inquiry that activates the icon 36 when necessary.

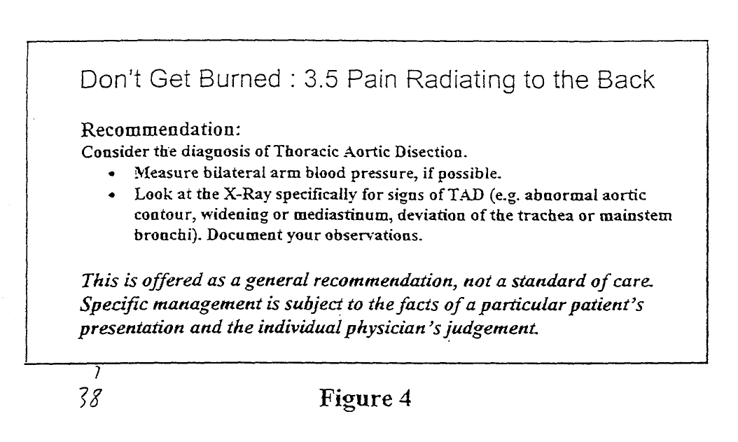

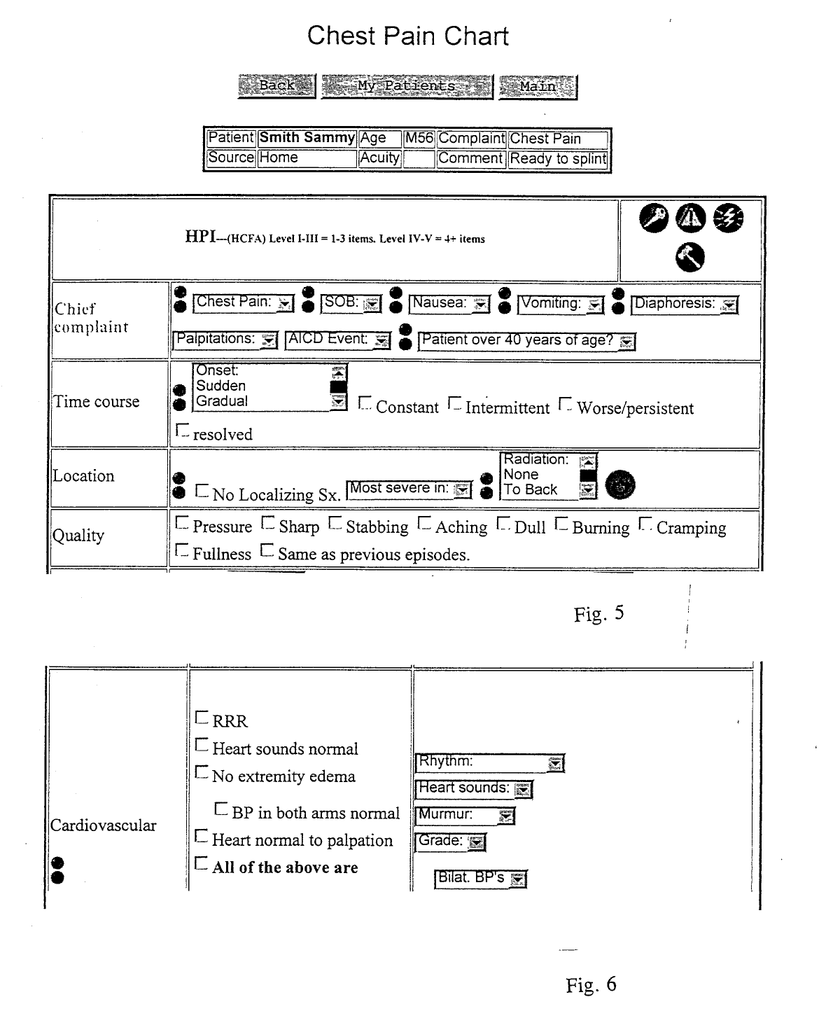

Upon activation of the icon 36, the health care professional can click on or otherwise query the icon 36. This might be done to find out what medical risk is presented or what additional medical care is necessary to reduce the medical risk resulting when the chest pain presented by the patient is radiating toward the back. This query causes an additional care legend or message to be presented on the communication device 18, such as the pop-up legend 38 shown as FIG. 4: “Recommendation: Consider the diagnosis of Thoracic Aortic Dissection (TAD). Measure bilateral arm blood pressure, if possible. Look at the X-ray specifically for signs of TAD (e.g. abnormal aortic contour, widening or mediastinum, deviation of the trachea or mainstem bronchi). Document your observations.” Thus, additional diagnostic steps are recommended to evaluate whether a TAD is present. The health care professional also is strongly encouraged to document his observations so the fact that the possibility of a TAD was thoroughly and quickly evaluated can be verified.

The medical risk raised by the symptom of chest pain radiating toward the back is that a TAD will be missed, as this is a condition that sometimes is not found quickly enough when a chest pain complaint is evaluated. This fact was ascertained by reviewing the results of malpractice actions in which liability was found because a TAD allegedly should have been diagnosed soon enough to avoid further complications, but was not.

This medical risk has two components. One component is that a health care professional must recognize the possibility of a TAD very rapidly to reach the best possible patient outcome.

The other component is that, even if the health care professional quickly recognizes and properly evaluates the possibility of a TAD, but rules it out as inconsistent with other diagnostic indications, the pertinent facts must be documented in the patient's chart immediately. Even if the patient's condition has been properly evaluated as ruling out a TAD, an anomalous TAD could exist that would not have been recognized by even a skilled physician. Alternatively, the patient might not be suffering from a TAD initially, but may develop this condition shortly after the diagnosis that no TAD is present. If the symptoms presented by the patient at the time of diagnosis are properly and quickly evaluated and documented, the best possible care has been given, and the health care professional will be able to show this fact by reference to the patient's chart.

The present invention addresses the need to quickly evaluate and document TAD in a patient presenting chest pain that radiates to the back. The template 24 responds to the selection of this characterization of the chest pain immediately by presenting a distinctive and unusual warning, here the fire icon 36, that additional diagnostic work is necessary to rule out an increased medical risk of a TAD in this instance. This information is presented only when it is needed, so if this condition is not presented there is no need to alarm or distract the medical health professional by presenting this information.

The present invention works equally well to signal the need for additional care, whether diagnostic or therapeutic, when other conditions posing an increased medical risk are presented.

Prompting System

A useful component of the present system is a prompting system that suggests or prompts the health care provider to include the important or critical elements of documentation of a patient's particular medical condition in the medical record. This component of the invention contains some aspects of simple medical logic. For example, the critical elements of documentation for a patient with a laceration are not known until the specific location of the laceration is known. Once the health care provider indicates the location of the laceration, the red light green light prompts then appear at the appropriate locations in the templated medical record.

Insurance company data and the scientific medical literature clearly indicate that poor medical record documentation, inadequate history taking and inadequate physical examinations are among the leading causes of medical errors, patient injuries and medical malpractice lawsuits. This part of the invention is designed to prompt health care practitioners to address factors in the history and physical examination that are critical to documenting a complete medical record, identifying important factors in the patient's history and physical examination, reduction in medical errors and resulting medical malpractice lawsuits.

The factors deemed critical to medical record documentation have been identified through an investigation by Daniel J. Sullivan, M.D., J. D., FACEP, into the scientific medical literature (multiple publications in the ED Legal Letter), and an analysis of over 100 malpractice lawsuits published in Dr. Sullivan's “High Risk Acute Care: The Failure to Diagnose).

The red light green light system are merely prompts; they are not mandatory. However, use of these prompts in a research setting, has led to an unprecedented level of documentation as demonstrated through published, juried, scientific publication (see Supplement to Annals of Emergency Medicine, October 2000 Volume 36 Number 4, Abstract # 216 entitled “On-Line Risk Management Combined With Template-Based Charting Improves the Documentation of Key Historical Data in Patients Presenting With Chest Pain.”

In addition, the use of the electronic template format allows the application of medical logic. It is impossible to know what factors in the history and physical examination are essential in patient care without some initial input from the practitioner. Once the practitioner begins entering information, the risk program responds by allowing previously invisible red lights, green lights to become visible. See Example 6 below.

The red light, green light prompts also assist the practitioner in considering the differential diagnosis. In the typical patient medical presentation, the patient first states a problem. Based upon this problem, or chief complaint, the practitioner then considers a list of possible diagnoses, called the differential diagnosis. This list of possible diagnoses guides the practitioner as to what questions to ask, what organ systems to evaluate, and which diagnostic tests to order. The prompts assist the practitioner in considering the diagnoses which are prone to being missed, or a particularly high-risk to the patient. The differential diagnosis each have a drop down list of risk factors, allowing the physician a method for immediate recall of difficult to remember historical items. This function is demonstrated in FIGS. 13 and 14.

Key Information Icons

Another aspect of the invention is immediate electronic access to critical information behind a “key information” icon, at various points throughout the many templates.

Medical practice is complex. Practitioners must remember or refer to a reference for a wide range of information. In actual practice, it is not possible to remember for an entire career, long lists of nerves with their specific function, long lists of tendons and how to test them, trauma scoring, croup scoring, Apgar scoring for the newborn, new standards of care and too many other lists, scores and other items to mention.

The simple fact is that practitioners need immediate reference to large amounts of diverse information that is often not immediately available in text, or on line. In addition, the busy practitioner seldom has time for looking up reference information.

Therefore, based upon research and practice, Daniel J. Sullivan, M.D., J. D., FACEP has provided immediate access via key information icons to lists of critical information, anatomical drawings, scores of various kinds, updates on standards of care, tendon identification and testing.

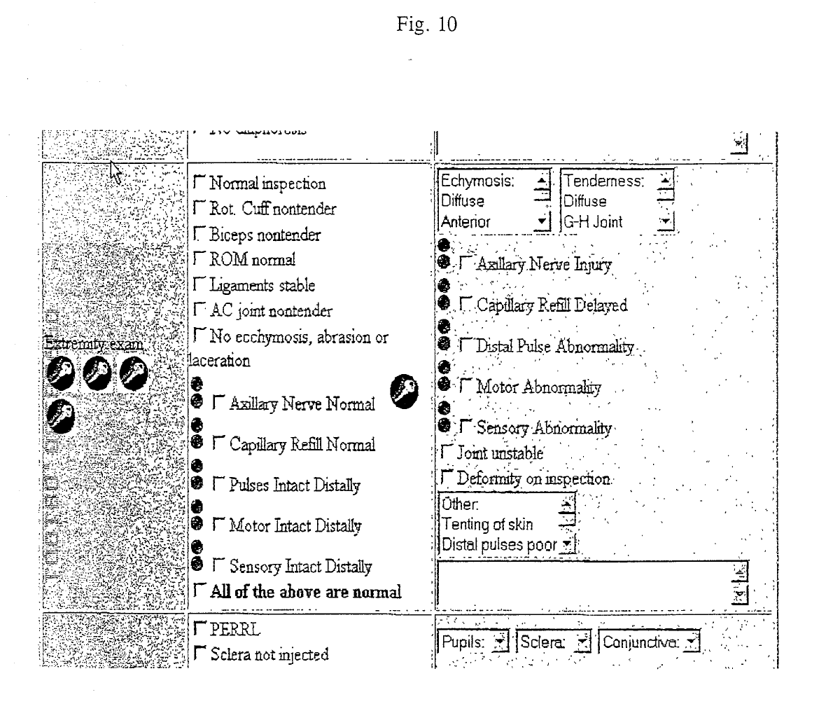

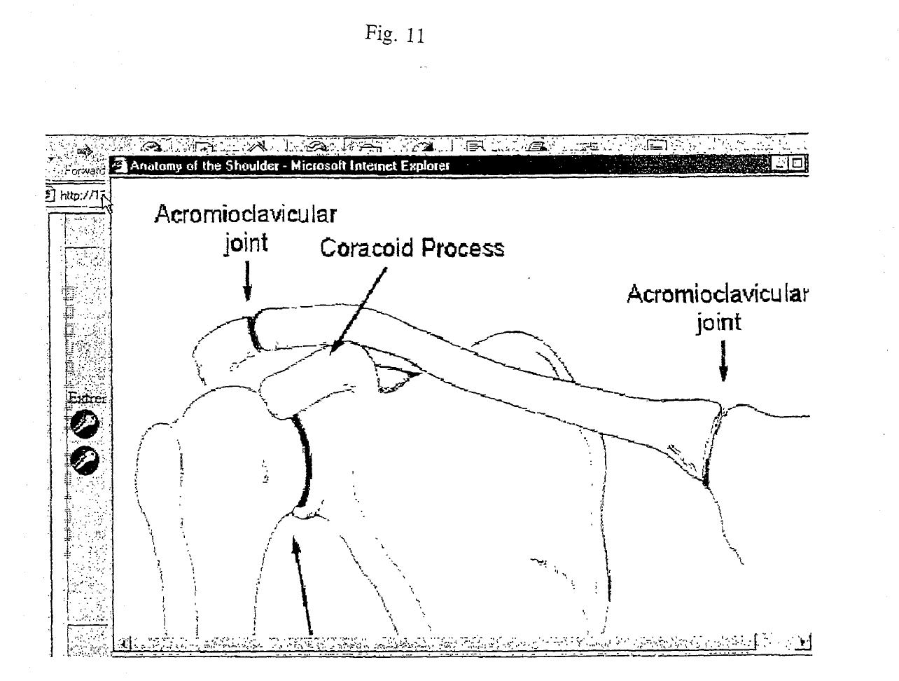

For example FIG. 10 demonstrates the extremity examination position of the shoulder injury electronic template. There are four key information icons in the gray area labeled extremity examination. The practitioner can place a cursor or touch mechanism over the labeled icons which will and with a single click demonstrate the anatomy of the shoulder (see FIG. 11). Thus, the practitioner has immediate access to information which simply may not be available in many medical settings.

There are over 100 key icons in one exemplary system, providing a wide range of critical information for the medical practitioner.

Triage High Risk Alert

When patients present to an emergency department with a medical problem, in most cases, they first see a nurse in an area outside of the department, called triage. Triage is the sorting of patients by severity of illness. There are several diagnoses which are so acute, that intervention must be immediate or the patient may suffer severe injury. It is critical that the staff in triage recognize this small group of acute emergencies and communicates this to the appropriate individuals, such as the physician on duty in the emergency department or the charge nurse. The group of diagnoses includes such things as the following: chest pain in a patient over 35 years of age; a patient presenting the a cold pulseless extremity; a child under 2 months of age with a fever, etc.

This invention provides the triage nurse with an electronic template which can include a drop down list of these high risk acute presentations. That part of the template contains a red light, green light prompt in order to obtain a high level of compliance with the use of this function. If the nurse chooses one of these high risk diagnoses, the program immediately pops up a warning indicating that immediate notification of the physician or charge nurse must occur. In this fashion, the combination of the red light, green light prompt and the high risk list assists the nurse in quickly identifying the acute emergencies and making the patient a high priority for treatment in the emergency department.

EXAMPLE 1
Abdominal Pain

| Patient Data | Medical Risk | Proposed Response |
|---|---|---|
| the patient is pregnant | A pregnant patient | Perform an ultrasound |
| | suffering from | study of the fetus and |
| | abdominal pain may | surrounding maternal |
| | have an ectopic | tissue. |
| | pregnancy, which is | |
| | not necessarily | |
| | determinable by | |
| | physical examination | |
| | and may be | |
| | misdiagnosed as | |
| | another condition. | |
| woman of child | Patients reporting | Test for pregnancy |
| bearing age with | information | |
| abdominal pain | inconsistent with | |
| | pregnancy, such as | |
| | abstinence from | |
| | intercourse, recent | |
| | menstruation, or the | |
| | use of contraceptives | |
| | often are nonetheless | |
| | pregnant. When a | |
| | pregnant person | |
| | presents abdominal | |
| | pain, the diagnosis of | |
| | ectopic pregnancy | |
| | should be considered. | |
| sudden onset of | A vascular event that | Test for a vascular |
| abdominal pain | requires quick | event |
| | treatment, such as | |
| | abdominal aortic | |
| | aneurysm (AAA), may | |
| | have occurred. AAA | |
| | is often overlooked, as | |
| | it can be difficult to | |
| | diagnose. | |
| The patient's | An AAA, which | Test for AAA |
| abdominal pain | requires quick | |
| radiates to the back or | treatment, may have | |
| to the flank. | occurred. | |

EXAMPLE 2
Neck Pain

| Patient Data | Medical Risk | Proposed Response |
|---|---|---|
| Blunt spine injury less | In a number of cases, | Blunt spine injury is |
| than eight hours before | liability has been found | treated with high dose |
| the time of diagnosis. | because the patient was | methylprednisolone if |
| | diagnosed with a spinal | treatment is begun |
| | cord injury several | within eight hours of |
| | hours (but fewer than | the injury. The |
| | eight hours) after the | literature does not |
| | injury, but | demonstrate any |
| | methylprednisolone | benefit beyond eight |
| | treatment to reverse | hours. |
| | the effects of spinal | 30 mg/kg bolus |
| | cord injury was not | administered IV |
| | started early enough to | over 15 min. |
| | improve the patient | 45 min. pause |
| | outcome. | Maintenance infusion |
| | | 5.4 mg/kg/hr for 23 |
| | | hours |
| The patient is | The intoxication may | Liberal ordering of the |
| intoxicated with | mask the effects of | trauma C-Spine series |
| alcohol or other | cervical spinal cord | is recommended in this |
| intoxicants. | injury or render the | setting. |
| | patient unable or | |
| | unwilling to cooperate. | |
| Neck pain, but no | Spinal cord injuries do | Don't rely solely on |
| radiologic (i.e. bone) | not always coincide | the absence of |
| abnormality in the x- | with spine damage | radiological |
| ray and no apparent | visible on x-rays or | abnormality and of |
| neurological changes. | stable neurological | present neurological |
| | changes. Transient | symptoms. Look |
| | neurologic changes | carefully at EMT |
| | may occur before the | (emergency medical |
| | emergency department | technician) and |
| | visit, and | nursing notes |
| | not be present | relating back to |
| | in the | the time of the injury. |
| | emergency department. | If there is prior |
| | Spinal Cord Injury | evidence of a |
| | Without Radiological | neurologic sign or |
| | Abnormality | symptom, |
| | (SCIWORA) is often | neurosurgical |
| | very difficult to | consultation, a period |
| | diagnose, sometimes | of observation or |
| | with catastrophic | hospital admission are |
| | results. | recommended. |

EXAMPLE 3
Chest Pain

| Patient Data | Medical Risk | Proposed Response |
|---|---|---|
| Chest Pain Radiating | This is a characteristic | Consider the diagnosis |
| to the Back | symptom of Thoracic | of TAD |
| | Aortic Dissection | Measure bilateral |
| | (TAD), which is often | arm blood |
| | missed in diagnosis | pressure, if |
| | because it often | possible. |
| | resembles other, less- | Look at the x-ray |
| | critical conditions. | specifically for |
| | TAD must be quickly | signs of TAD (e.g. |
| | diagnosed and treated | abnormal aortic |
| | to avoid death. | contour, widening |
| | | or mediastinum, |
| | | deviation of the |
| | | trachea or |
| | | mainstem bronchi). |
| | | Document your |
| | | observations. |
| Chest pain PLUS: | Where chest pain is the | Do one of the |
| One major risk | only clinically apparent | following: |
| factor | symptom of an acute | Obtain |
| (smoking, | myocardial infarction | cardiology |
| hypertension, | (AMI), that diagnosis | consultation |
| diabetes, family | is often prematurely | Observation |
| history (Hx), | ruled out in favor of | status to rule |
| high | other possible | out myocardial |
| cholesterol) or | conditions (often due | infarction |
| A history of | to coinciding | Admit |
| coronary artery | symptoms of lesser | |
| disease | problems, like | |
| | indigestion) and the | |
| | patient is discharged. | |
| | This delayed or missed | |
| | diagnosis frequently | |
| | results in death of the | |
| | patient. | |

EXAMPLE 4
Headache

| Patient Data | Medical Risk | Proposed Response |
|---|---|---|
| This is reported as | This is a two-step risk. | (1) Order a non- |
| the worst headache | First, a very bad | infused CT of the |
| of the patient's | headache may be | head to rule out a |
| entire life. | caused by a | subarachnoid |
| | subarachnoid | hemorrhage. |
| | hemorrhage. Even | (2) Proceed with |
| | though few severe | lumbar puncture |
| | headaches are caused | even if the CT of |
| | by a subarachnoid | the head is read as |
| | hemorrhage, the | negative for |
| | patient outcome is poor | bleeding. |
| | unless the condition is | |
| | quickly diagnosed and | |
| | treated. | |
| | Second, even if a 4^{th} | |
| | generation CT of the | |
| | head is carried out, | |
| | sometimes it will not | |
| | be read as showing | |
| | bleeding when the | |
| | patient in fact has a | |
| | subarachnoid | |
| | hemorrhage. | |

EXAMPLE 5
Testicular Pain

| Patient Data | Medical Risk | Proposed Response |
|---|---|---|
| Abdominal pain, but | Torsion of the testicle | Consider torsion in the |
| no testicular pain | is a difficult diagnosis, | differential diagnosis. |
| | and is often missed, as | |
| | often the patient's site | |
| | of discomfort is in the | |
| | abdomen, rather than | |
| | the testicles. | |
| sudden onset of pain | Sudden onset of severe | Immediately consider |
| | pain should rule out | the diagnosis of torsion |
| | epididymitis, but often | testicle |
| | does not. Torsion | |
| | testicle must be | |
| | immediately | |
| | diagnosed, since | |
| | salvage of the testicle | |
| | is only highly probable | |
| | within six hours of the | |
| | onset of pain. | |

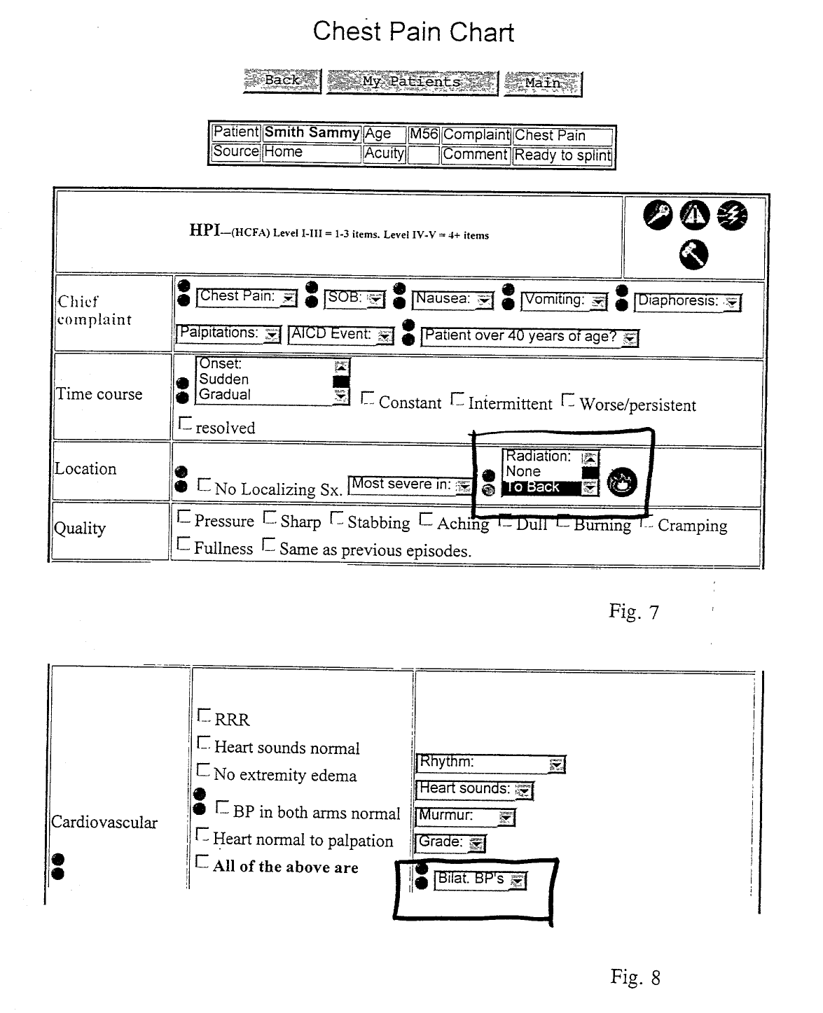

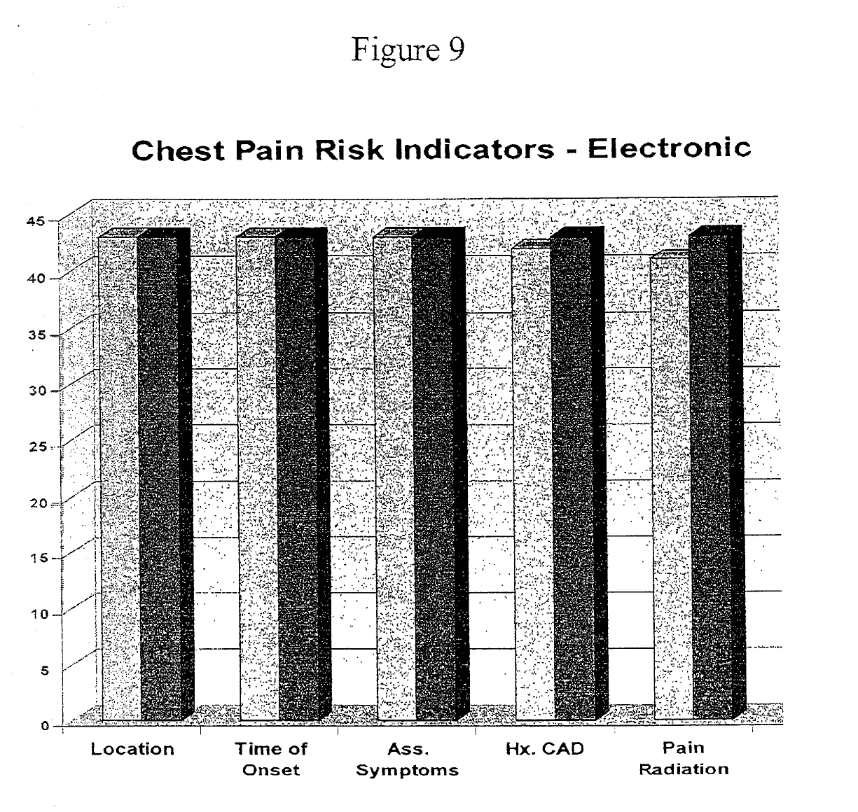

EXAMPLE 6
Template

| | | |
|---|---|---|
| Chest Pain | Practitioner | Red light, green light, previously |
| | indicates that chest | invisible now lights up next to |
| | pain radiates to the | bilateral blood pressures in the |
| | back. (see FIG. 7) | cardiovascular examination. Thus, |
| | | the practitioner measures bilateral |
| | | blood pressures, documents the |
| | | result, specifically looking for and |
| | | documenting the examination for a |
| | | Thoracic Aortic Dissection. |
| Laceration | Practitioner | Red lights, green lights previously |
| Template | indicates in the | invisible in the extremity |
| | history that the | examination now light up. If the |
| | laceration involves | injury is in the extremity, critical |
| | an extremity. | documentation includes examination |
| | | of the pulses, distal neurologic |
| | | system and tendons. |

1. Apparatus for improving the medical care of patients, comprising:
A. an input device for entering medical data presented by a patient, the data defining a patient data record;
B. a medical risk database that associates:
i. certain patient data in said patient data record that increases the risk of a missed medical care opportunity, with
ii. additional medical care that would reduce the risk of a missed medical care opportunity, despite the presentation of said certain patient data;
C. a data processor programmed to compare said patient data record with said medical risk database to identify patient data in said record that increases the risk of a missed medical care opportunity;
D. a communication device, responsive to the identification of patient data that increases the risk of a missed medical care opportunity, that communicates additional medical care that will reduce the risk of a missed medical care opportunity.

2. The medical care improving apparatus of claim 1, further comprising a data storage device for maintaining said patient data record.

3. The medical care improving apparatus of claim 2, in which said data storage device comprises a read/write drive.

4. The medical care improving apparatus of claim 3, in which said read/write drive is located in a portable computer.

5. The medical care improving apparatus of claim 2, in which said data storage device is positioned in proximity to a patient examination area.

6. The medical care improving apparatus of claim 2, in which said data storage device is positioned remotely with respect to a patient examination area.

7. The medical care improving apparatus of claim 6, further comprising a communication device associated with said input device for establishing a communication link between said data storage device and said input device.

8. The medical care improving apparatus of claim 1, in which said medical risk database is a compilation of information derived from medical malpractice litigation.

9. The medical care improving apparatus of claim 1, in which said input device is a keyboard.

10. The medical care improving apparatus of claim 1, in which said input device is a cursor movement device.

11. The medical care improving apparatus of claim 1, in which said input device is a touch screen.

12. The medical care improving device of claim 1, further comprising an interactive display associated with said input device for displaying said patient data to an attending health care professional as it is entered.

13. The medical care improving device of claim 12, further comprising a diagnostic protocol template displayed by said interactive display and adapted to elicit said patient data.

14. The medical care improving device of claim 12, in which said interactive display also functions as said communication device.

15. The medical care improving device of claim 13, in which said communication device communicates on said template additional medical care that would reduce the risk of a missed medical care opportunity.

16. The medical care improving device of claim 13, in which said template includes at least one field presented on said visual display for entering certain patient data that increases the risk of a missed medical care opportunity.

17. The medical care improving device of claim 16, in which said communication device displays on said visual display, in proximity to said field, information about additional medical care that would reduce the risk of a missed medical care opportunity.

18. The medical care improving device of claim 1, in which said communication device responds to the entry of patient data, shortly after the entry of said data, by providing information about additional medical care that would reduce the risk of a missed medical care opportunity.

19. The medical care improving device of claim 18, in which said communication device responds within 10 minutes after the entry of said data.

20. The medical care improving device of claim 18, in which said communication device responds within 2 minutes after the entry of said data.

21. The medical care improving device of claim 18, in which said communication device responds within 1 minute after the entry of said data.

22. The medical care improving device of claim 18, in which said communication device responds within 30 seconds after the entry of said data.

23. The medical care improving device of claim 18, in which said communication device responds within 20 seconds after the entry of said data.

24. The medical care improving device of claim 18, in which said communication device responds within 10 seconds after the entry of said data.

25. The medical care improving device of claim 18, in which said communication device responds within 5 seconds after the entry of said data.

26. The medical care improving device of claim 18, in which said communication device responds within 4 seconds after the entry of said data.

27. The medical care improving device of claim 18, in which said communication device responds within 2 seconds after the entry of said data.

28. The medical care improving device of claim 18, in which said communication device responds within 1 second after the entry of said data.

29. The medical care improving apparatus of claim 1, in which said communication device is a video display operatively connected to said data processor to display an indication of appropriate additional medical care.

30. The medical care improving apparatus of claim 1, in which said communication device is an alarm providing a signal perceptible to a health care professional.

31. The medical care improving apparatus of claim 30, in which said alarm is selectively perceptible to a health care professional and not to the patient.

32. The medical care improving apparatus of claim 30, in which said alarm is encoded, to avoid alarming a patient who happens to encounter it.

33. An interactive method for avoiding medical risk during a medical diagnostic procedure carried out by a health care professional, comprising:
A. identifying medical data presented by the patient;
B. recording said medical data in a data storage device, forming data records;
C. maintaining on a data storage medium a medical risk database that associates:
i. certain medical data that increases the risk of a missed medical care opportunity, and
iii. additional medical care that would reduce the risk of a missed medical care opportunity, despite the presentation of said certain medical data;
D. comparing the medical data presented by the patient with said medical risk database to identify whether medical data presented by the patient is associated with a risk of a missed medical care opportunity;
E. if medical information presented by the patient is associated with a risk of a missed medical care opportunity, communicating to said health care professional information about additional medical care that would reduce the risk of a missed medical care opportunity.

34. An interactive diagnostic template for medical diagnosis, said template comprising:
A. a multiplicity of indicia indicating potential symptoms contributing to a diagnosis;
B. said symptoms including:
i. a first subset of prompted symptoms that should routinely be checked to properly document the diagnosis; and
ii. a second subset of optional symptoms that can be checked at the option of an attending health care professional; and
C. symbols associated with said prompted symptoms that have a first condition when the evaluation of a prompted symptom has not yet been documented and a second, visibly distinct condition when evaluation of the prompted symptom has been documented.

35. The interactive diagnostic template of claim 34, wherein the first condition of said symbols is a representation of a lit red light and the second condition of said symbols is a representation of a lit green light.

36. The interactive diagnostic template of claim 34, further comprising:
A. indicia indicating at least one conditionally prompted symptom that is prompted when at least a first other associated prompted symptom is present but not prompted if the other associated prompted symptom is absent; and
B. a symbol associated with said conditionally prompted symptom that:
i. is displayed only if the associated prompted symptom is documented; and
iii. when displayed, has a first condition when the conditionally prompted symptom has not yet been investigated and a second, visibly distinct condition when evaluation of the conditionally prompted symptom has been documented.

37. The interactive diagnostic template of claim 36, wherein the first condition of said symbol associated with said conditionally prompted symptom is a representation of a lit red light and the second condition of said symbol is a representation of a lit green light.

38. An interactive diagnostic template for medical triage of a patient, comprising:
A. a display presenting a list of acute emergencies that require immediate notification to a treating medical professional;
B. at least one symbol associated with at the acute emergency list that has a first condition prompting a triaging medical professional to evaluate whether any of the acute emergencies exists and a second, visibly distinct condition when the triaging medical professional has ruled out all of the acute emergencies; and
C. a warning signal to the triaging medical professional, responsive to the documentation of an acute emergency, to notify a treating medical professional immediately.

39. The triage template of claim 38, comprising a first display of said warning for use by a medical professional who is conducting triage and a second display of said warning signal positioned remotely from said first display for use by another medical professional who should know if a patient in triage is suffering from an acute emergency condition.

40. The triage template of claim 38, wherein the first condition of said symbol is a representation of a lit red light and the second condition of said symbol is a representation of a lit green light.

41. An interactive diagnostic template for medical diagnosis, said template comprising:
A. a multiplicity of indicia indicating potential symptoms contributing to a diagnosis; and
B. at least one key information icon associated with at least one potential symptom, indicating that additional information pertinent to the potential symptom is available for review upon request; and
C. an input device for requesting a display of the additional information associated with said icon.

42. The template of claim 41, wherein said additional information comprises at least one anatomical drawing of the site of the symptom associated with said icon.

43. The template of claim 41, wherein said additional information comprises at least one diagnostic score relating to the symptom associated with said icon.

44. The template of claim 41, wherein said additional information comprises an updates on the standard of care relating to the symptom associated with said icon.

45. The template of claim 41, wherein said additional information comprises information on how to test for the symptom associated with said icon.
